(19) United States
(12) Patent Application Publication
(10) Pub. No.: US 2008/0147217 A1
(43) Pub. Date: Jun. 19, 2008

(54) MOTION RESPONSIVE PORTABLE MEDIA PLAYER

(75) Inventors: Shin-Hong Chung, Shenzhen City (CN); Kun-Chih Hsieh, Shenzhen City (CN); Kuan-Hong Hsieh, Shenzhen City (CN); Xiao-Guang Li, Shenzhen City (CN)

Correspondence Address: NORTH AMERICA INTELLECTUAL PROPERTY CORPORATION, P.O. BOX 506, MERRIFIELD, VA, 22116, US

(73) Assignees: ENSKY TECHNOLOGY (SHENZHEN) CO., LTD., Shenzhen City (CN); ENSKY TECHNOLOGY CO., LTD., Taipei Hsien (TW)

(21) Appl. No.: 11/955,372

(22) Filed: Dec. 12, 2007

(30) Foreign Application Priority Data
Dec. 13, 2006 (CN) 200610201287.X

(51) Int. Cl. G06F 17/00

(52) U.S. Cl. 700/94

(57) ABSTRACT

A motion responsive portable media player is provided. The portable media player includes a processing unit and at least one vibration part. The vibration part acts as an input unit and operates independently of the input unit. The vibration part includes a swing means and at least one pressure sensor. The swing means is configured for hitting the pressure sensor in response to deliberate shake motions imparted on the portable media player by the user, and the pressure sensor is configured for generating a signal to the processing unit in response to a hit operation thereon. When successively receiving a predetermined number of signals from the pressure sensor during playing of musical files, the processing unit performs a predetermined operation in responsive to the predetermined number of signals.

### BACKGROUND

1. Technical Field

The present invention relates to portable media players, and particularly to a motion responsive portable media player.

2. General Background

Media players have become popular personal entertainment devices because of their small size. Media players may have a user interface in the form of a scroll wheel and/or a set of buttons to navigate programs or applications displayed on the screen and to access functions of the media players. However, for some interfaces, navigation can be difficult. One reason is that the display screen may be small and therefore the user may have difficulties in seeing what is being displayed. Another reason is that a user may have poor reading vision or otherwise be visually impaired. In other situations whereby the user cannot look at the screen, the user may have difficulty navigating the user interface because the user may not be able to shift visual focus away from an important task and towards the user interface. Such tasks or activities may include, for example, driving an automobile or crossing the street.

What is needed, therefore, is a simple, intuitive, and efficient user interface that allow a user to conveniently manipulate the media player.

### SUMMARY

A motion responsive portable media player is provided. The portable media player includes a processing unit and at least one vibration part. The vibration part acts as an input unit and operates independently of the input unit. The vibration part includes a swing means and at least one pressure sensor. The swing means is configured for hitting the pressure sensor in response to deliberate motions imparted on the portable media player by the user, and the pressure sensor is configured for generating a signal to the processing unit in response to a hit operation thereon. When successively receiving a predetermined number of signals from the pressure sensor during playing of musical files, the processing unit performs a predetermined operation in responsive to the predetermined number of signals.

Other advantages and novel features will be drawn from the following detailed description with reference to the attached drawing.

### BRIEF DESCRIPTION OF THE DRAWINGS

The components of the drawings are not necessarily drawn to measuring scale, the emphasis instead being placed upon clearly illustrating the principles of the portable media player. Moreover, in the drawings, like reference numerals designate corresponding parts throughout the several views.

FIG. 1 is a block diagram of hardware infrastructure of a motion responsive portable media player.

FIG. 2 is a schematic diagram of infrastructure of a vibration part of the portable media player of FIG. 1 in accordance with a first embodiment of the present invention.

FIG. 3 is a schematic diagram of infrastructure of a vibration part of the portable media player of FIG. 1 in accordance with a second embodiment of the present invention.

FIG. 4 is a schematic diagram of infrastructure of a vibration part of the portable media player of FIG. 1 in accordance with a third embodiment of the present invention.

FIG. 5 is a schematic diagram showing the portable media player of FIG. 1 configured with a vibration part in its one side.

FIG. 6 is schematic diagram showing the portable media player of FIG. 1 respectively configured with a vibration part in its two adjacent sides.

### DETAILED DESCRIPTION OF THE EMBODIMENT

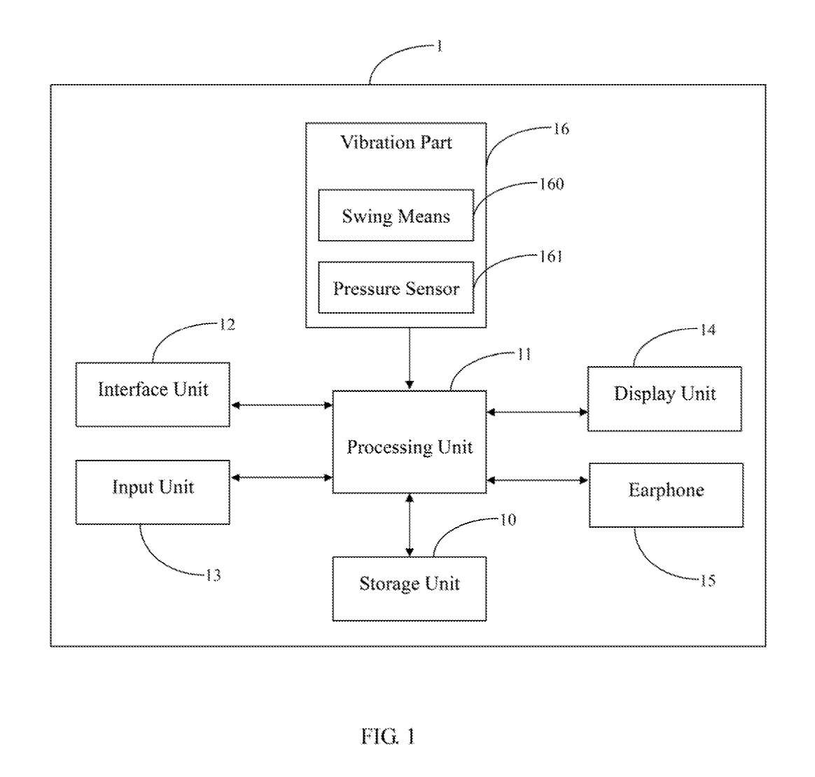

FIG. 1 is a block diagram of hardware infrastructure of a motion responsive portable media player in accordance with a preferred embodiment of the present invention. The portable media player 1 is capable of performing a particular function, e.g., changing a play arrangement of musical files in the portable media player 1, changing an output volume of the portable media player 1, and so on, in response to a user imparting a physical shaking motion upon the portable media player 1.

The portable media player 1 includes a storage unit 10, a processing unit 11, an interface unit 12, an input unit 13, a display unit 14, and an earphone 15. The storage unit 10 includes a computer readable media in the form of volatile memory, such as random access memory (RAM), and non-volatile memory, such as read only memory (ROM) or flash memory. The non-volatile memory is configured for storing musical files, control programs, and other type of data needed by the portable media player 1. The control programs may perform a plurality of functions, for example, selection of musical files, generation of playlists and/or the automatic re-ordering of playlists, adjustment of output volume of the portable media player 1, and so on. The volatile memory is configured for storing data and/or the control programs that are immediately accessible to and/or presently be operated on by the processing unit 11.

The interface unit 12, such as a Universal Serial Bus (USB) interface, is configured for communicating with an external electronic device, such as a personal computer, a portable storage device. The input unit 13 is configured for receiving a user's input and generating signals to the processing unit 11. The input unit 13 may include buttons, touch pads, touch screens and the like. The display unit 14 is configured for visually outputting both graphics and alphanumeric characters. The earphone 15 is configured for transforming signals from the processing unit 11 to voice signals.

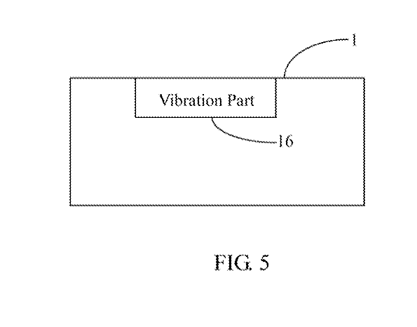

The portable media player 1 further includes a vibration part 16. The vibration part 16 acts as the input unit 13 and operates independently of the input unit 13. The vibration part 15 is designed to be on the inside of the portable media player 1, for example, as shown in FIG. 5, it can be confined to one side of the portable media player 1. The vibration part 16 includes a swing means 160 and at least one pressure sensor 161. The pressure sensor 161 is electrically coupled to the processing unit 11, and is configured for generating a signal to the processing unit 11 in response to a hit operation thereon.

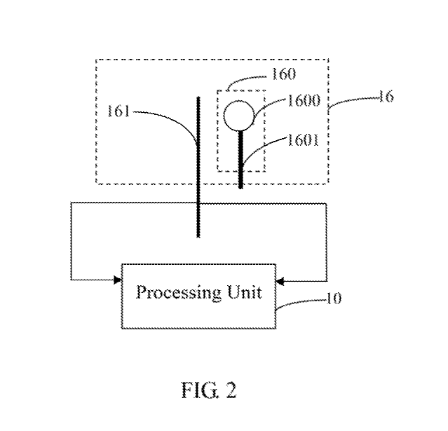

Referring to FIG. 2, the swing means 160 consists of a spherule 1600 and an elastic pole 1601. The spherule 1600 is configured on one end of the elastic pole 1601. When the user imparts the shake motions on the portable media player 1, the spherule 1600 hits the pressure sensor 161, and the pressure sensor 161 generates a signal in response to a hit operation thereon, and transmits the signal to the processing unit 11 for processing.

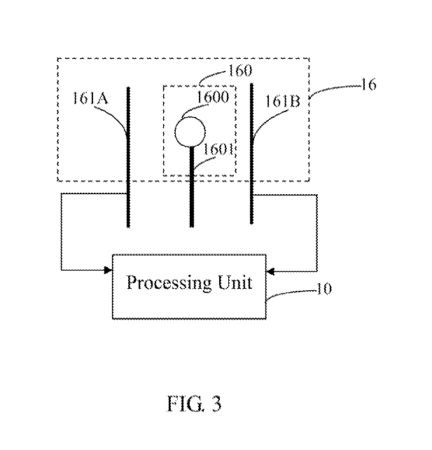

Referring to FIG. 3, the vibration part 16 consists of the swing means 160 of FIG. 2 and two pressure sensors 161A and 161B. Each of the pressure sensors 161A and 161B is electrically coupled to the processing unit 11, and is assigned with a coordinate for identification. The swing means 160 is configured between the two pressure sensors 161A and 161B. When the user imparts the shake motions on the portable media player 1, the spherule 1600 hits the two pressure sensors 161A and 161B back and forth, and the two pressure sensors 161A and 161B generates the signals in response to the hit operations thereon, and transmit the signals to the processing unit 11 for processing.

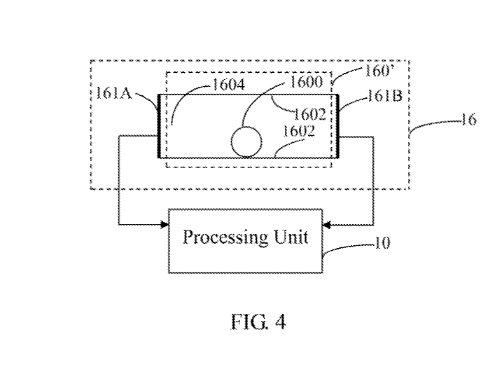

Referring to FIG. 4, the vibration part 160 consists of a swing means 160′ and two pressure sensors 161A and 161B. The swing means 160′ consists of the spherule 1600 and two slides 1602. The two slides 1602 and the two pressure sensors 161A and 161B form a sealed cavity 1604. When the user imparts the shake motions on the portable media player 1, the spherule 1600 slides in the sealed cavity 1604, and hits the two pressure sensors 161A and 161B. The two pressure sensors 161A and 161B generate the signals in response to the hit operations thereon, and transmit the signals to the processing unit 11 for processing.

The processing unit 11 identifies the signals generated from the pressure sensor(s) 161 during playing of musical files, and determines whether a number of the identified signals reaches a predetermined number. If the number of the identified signals does not reach the predetermined number, namely where the user may inadvertently shake the portable media player 1, the processing unit 11 filters the signals. If the number of the identified signals reaches the predetermined number, namely where the user deliberately shakes the portable media player 1 to perform a particular function, the processing unit 11 performs a predetermined operation according to the identified signals.

The predetermined operation can be one of randomly selecting a musical file and playing the selected musical file, and updating a current playlist according to a random function. In addition, when the signals are generated from a plurality of pressure sensors 161, such as that of FIG. 3 or 4, the processing unit 11 further determines a direction of the shake motions according to the coordinates of the pressure sensors 161, and performs a corresponding predetermined operation according to the direction. For example, if the direction is a first direction, the corresponding predetermined operation can be one of playing a next musical file and increasing the output volume of the portable media player 1, and if the direction is a second direction that is opposite to the first direction, the corresponding predetermined operation can be one of playing a previous musical file and decreasing an output volume of the portable media player 1.

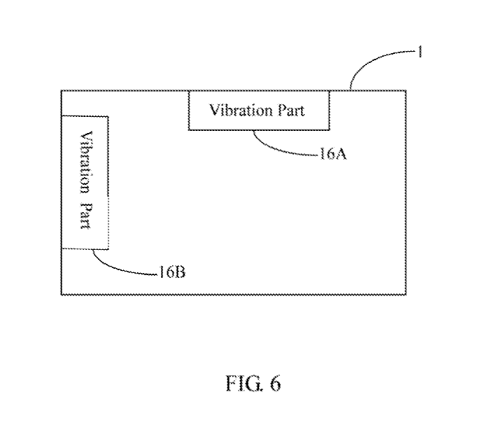

Referring to FIG. 6, the portable media player 1 is equipped with two vibration parts 16A and 16B. The two vibration parts 16A and 16B are configured on an adjacent side of the portable media player 1 respectively, such as that shown in FIG. 6. Each of the vibration parts 16A and 16B is assigned with a particular function.

For example, in a first exemplary embodiment, the vibration part 16A is configured for randomly selecting a musical file in response to the deliberate shake motions thereon while the vibration part 16B is configured for adjusting the output volume of the portable media player 1 in response to the deliberate shake motions thereon.

In a second exemplary embodiment, the vibration part 16A is configured for randomly selecting a musical file in response to the deliberate shake motions thereon while the vibration part 16B is configured for forward or backward playing a musical file in response to the deliberate shake motions thereon.

In a third exemplary embodiment, the vibration part 16A is configured for updating the current playlist in response to the deliberate shake motions thereon while the vibration part 16B is configured for adjusting the output volume of the portable media player 1 in response to the deliberate shake motions thereon.

In a fourth exemplary embodiment, the vibration part 16A is configured for updating the current playlist in response to the deliberate shake motions thereon while the vibration part 16B is configured for forward or backward playing a musical file in response to the deliberate shake motions thereon. However, it should be noted that the function assigned to each vibration part 16 is not limited to that described above.

Utilizing the portable media player 1, the user can directly shake the portable media player 1 to perform a predetermined function, without engaging a finger manipulated button or looking at the portable media player 1 to find a particular interface control element, and thus can be done with less sensory distraction or concentration than traditional media players.

Although the present invention has been specifically described on the basis of a preferred embodiment thereof, the invention is not to be construed as being limited thereto. Various changes or modifications may be made to the embodiment without departing from the scope and spirit of the invention.

What is claimed is:

1. A motion responsive portable media player comprising:
a processing unit; and
at least one vibration part comprising a swing means and at least one pressure sensor, wherein the swing means is configured for hitting the pressure sensor in response to shake motions imparted on the portable media player by the user, and the pressure sensor is configured for generating a signal to the processing unit in response to a hit operation thereon;
wherein when the processing unit successively receives a predetermined number of signals from the pressure sensor during playing of musical files, the processing unit performs a predetermined operation in responsive to the predetermined number of signals.

2. The portable media player according to claim 1, wherein the predetermined operation is one of randomly selecting a musical file and playing the selected musical file, and updating a current playlist according to a random function.

3. The portable media player according to claim 1, wherein when the vibration part comprises a plurality of pressure sensors, each of the pressure sensors is assigned with a coordinate for identification, and the processing unit determines a direction of the shake motions according to the coordinates of the pressure sensors, and performs a corresponding predetermined operation according to the direction.

4. The portable media player according to claim 3, wherein when the direction is a first direction, the corresponding predetermined operation is one of playing a next musical file and increasing an output volume of the portable media player, and when the direction is a second direction, the corresponding predetermined operation is one of playing a previous musical file and decreasing the output volume of the portable media player.

5. The portable media player according to claim 1, wherein the swing means comprises a spherule and an elastic pole, wherein the spherule is configured on one end of the elastic pole.

6. The portable media player according to claim 3, wherein the vibration part comprises two pressure sensors, and the swing means comprises a spherule and two slides, wherein the two slides and the two pressure sensors form a sealed cavity.
